(19) United States
(12) Patent Application Publication
(10) Pub. No.: US 2013/0062901 A1
(43) Pub. Date: Mar. 14, 2013

(54) STRUCTURE FOR EXCHANGING AIR FILTER FOR VEHICLE

(71) Applicant: Dong Won Yeon, Hwaseong-si (KR)

(72) Inventor: Dong Won Yeon, Hwaseong-si (KR)

(73) Assignee: Kia Motors Corporation, Seoul (KR)

(21) Appl. No.: 13/342,735

(22) Filed: Jan. 3, 2012

(30) Foreign Application Priority Data
Sep. 9, 2011 (KR) 10-2011-0091575

(51) Int. Cl. B60R 7/06

(52) U.S. Cl. 296/37.12

(57) ABSTRACT

A structure for exchanging an air filter for a vehicle, may include the air filter accommodated in an air conditioning device, and a glove box housing provided on a dashboard and having an accommodation space formed therein, wherein the air filter exchanging portion may be formed on the glove box housing inside thereof to communicate with the air filter.

### CROSS-REFERENCE TO RELATED APPLICATION

The present application claims priority to Korean Patent Application No. 10-2011-0091575, filed on Sep. 9, 2011 in the Korean Intellectual Property Office, the entire contents of which is incorporated herein for all purposes by this reference.

### BACKGROUND OF THE INVENTION

1. Field of the Invention

The present invention relates to a structure for exchanging an air filter for a vehicle, and more particularly, to a structure for exchanging an air filter for a vehicle, which makes it possible to easily exchange an air filter of an air conditioning device.

2. Description of Related Art

In general, an air conditioning device provided in a vehicle includes an air filter that is one of components which purify air that is supplied to the inside of the vehicle.

Such an air filter is positioned in the rear of a glove box, and in order to exchange the air filter, it is required to take away the whole glove box from a dashboard or to separate a damper and a stopper of a housing of the glove box to deteriorate workability.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a structure for exchanging an air filter for a vehicle, which makes it possible to easily exchange an air filter of an air conditioning device that is positioned in the rear of a glove box and thus can improve the workability.

In one aspect of the present invention, a structure for exchanging an air filter for a vehicle, may include the air filter accommodated in an air conditioning device, and a glove box housing provided on a dashboard and having an accommodation space formed therein, wherein the air filter exchanging portion is formed on the glove box housing inside thereof to communicate with the air filter.

Wherein an air filter cover for opening and closing the air filter is mounted on an inlet portion of the air conditioning device through which the air filter is drawn in and out, and wherein the inlet portion of the air conditioning device is disposed in the glove box housing.

The air filter exchanging portion is penetratingly formed on an upper portion of one side surface of the glove box housing that faces the air filter and covered by the air filter cover.

The air filter is installed through the inlet portion of the air conditioning device and is inclined downward at a predetermined angle toward the air filter exchanging portion.

An inlet portion of the air conditioning device through which the air filter is drawn in and out is projected for a predetermined distance toward a glove box cover.

Cooled air of the air conditioning device that flows into the glove box housing is discharged to an outside through the air filter exchanging portion.

As described above, according to the structure for exchanging an air filter for a vehicle according to the present invention, the air filter can be easily exchanged through the air filter exchanging portion of the glove box housing that communicates with the air filter, and thus the workability can be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a side view illustrating a structure for exchanging an air filter for a vehicle according to an exemplary embodiment of the present invention.

FIG. 2 is a perspective view illustrating a glove box cover in an open state showing a structure for exchanging an air filter for a vehicle according to an exemplary embodiment of the present invention.

FIG. 3 is a perspective view illustrating an air filter cover of FIG. 2 in a separated state.

FIG. 4 is a view explaining a process of exchanging an air filter through a structure for exchanging an air filter for a vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, preferred embodiments of the present invention will be described with reference to the accompanying drawings.

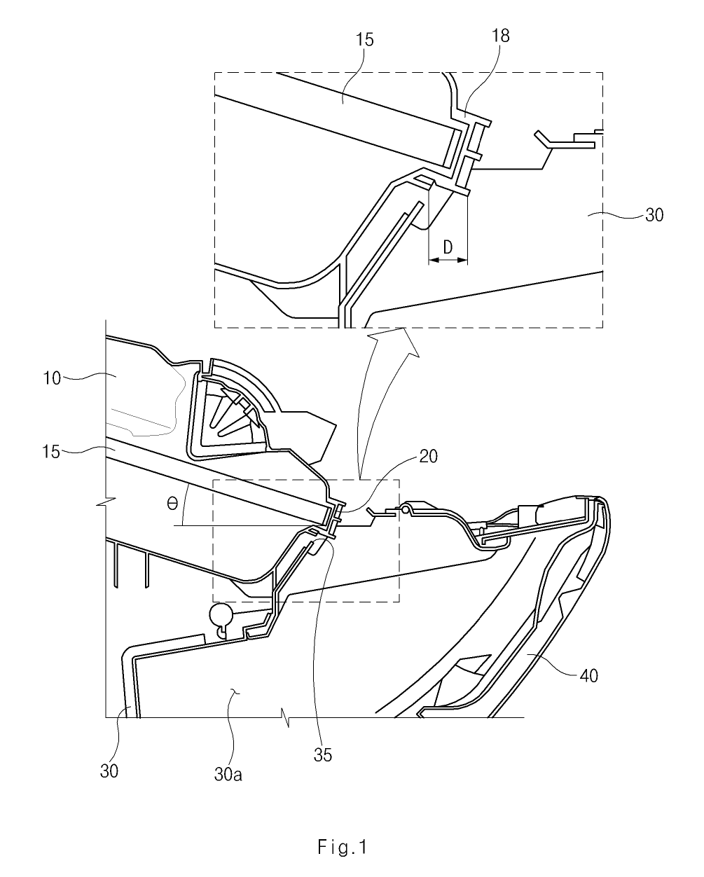

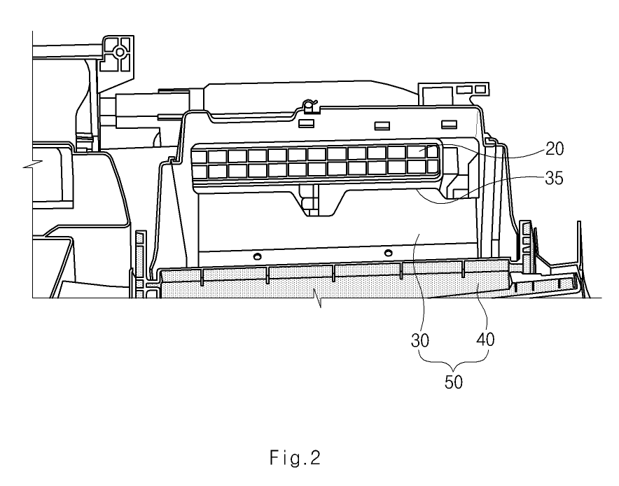

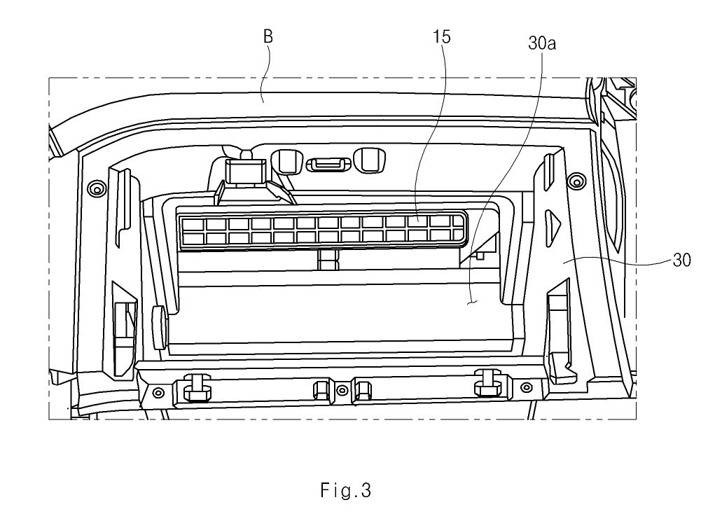

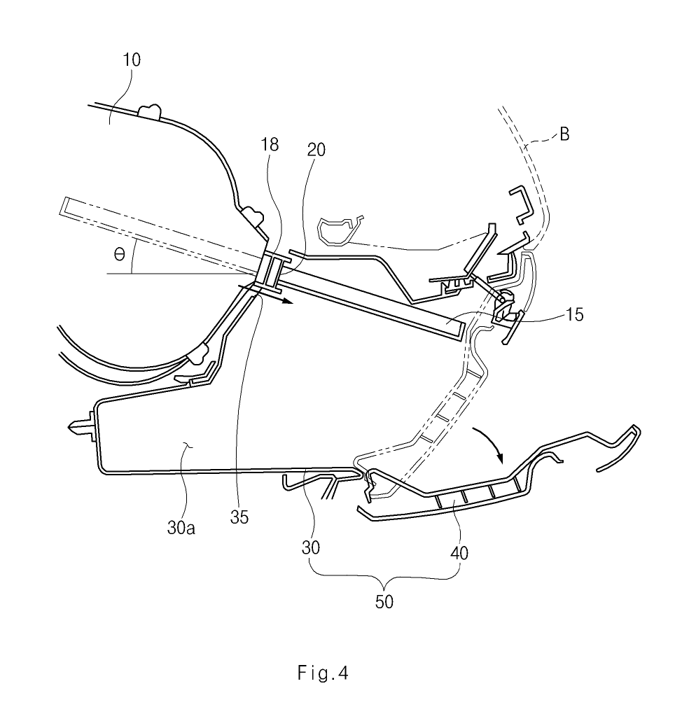

FIG. 1 is a side view illustrating a structure for exchanging an air filter for a vehicle according to an exemplary embodiment of the present invention. FIG. 2 is a perspective view illustrating a glove box cover in an open state showing a structure for exchanging an air filter for a vehicle according to an exemplary embodiment of the present invention, and FIG. 3 is a perspective view illustrating an air filter cover of FIG. 2 in a separated state. FIG. 4 is a view explaining a process of exchanging an air filter through a structure for exchanging an air filter for a vehicle according to an exemplary embodiment of the present invention.

A structure for exchanging an air filter for a vehicle according to an exemplary embodiment of the present invention, as illustrated in FIGS. 1 to 4, includes the air filter 15 accommodated in an air conditioning device 10, and a glove box 50 provided on a dashboard B and having an air filter exchanging portion 35 formed thereon to communicate with the air filter 15.

The air filter 15 is a component which purifies air that is supplied to the inside of the vehicle, and is positioned in the rear of the glove box 50.

At this time, it is preferable that on an inlet portion 18 of the air conditioning device through which the air filter 15 is drawn in and out, an air filter cover 20 for opening and closing the air filter 15 is mounted. Accordingly, the air filter exchanging portion 35 is in a closed state by the air filter cover 20, and thus goods accommodated in an accommodation space 30a do not secede through the air filter exchanging portion 35.

Further, water that is produced by the air filter cover 20 in the air conditioning device 10 can be prevented from dropping to the glove box 50.

On the other hand, the inlet portion 18 of the air conditioning device 10 through which the air filter 15 is drawn in and out is projected for a predetermined distance D toward the air filter exchanging portion 35, and thus a user can easily exchange the air filter 15 through the inlet portion 18.

In addition, the air filter 15 that is accommodated in the air conditioning device 10 is mounted to be inclined downward at a predetermined angle θ toward the air filter exchanging unit 35, and thus after a user pulls the air filter 15 forward, the air filter 15 is naturally drawn toward the air filter exchanging unit 35 due to its own weight. Accordingly, the work can be done with convenience, and the interference with the glove box housing 30 can be avoided during exchanging of the air filter 15.

The glove box 50 is positioned in front of the air filter 15, and includes a glove box housing 30 in which a good accommodation space 30a is formed, and a glove box cover 40 that opens and closes a front surface of the glove box housing 30.

The glove box cover 40 is rotatably mounted around a lower end of the glove box housing 30.

The glove box housing 30 is fixedly installed on the dashboard B, and the rear surface of the glove box housing 30 faces the air filter 15.

In this case, the air filter exchanging portion 35 is penetratingly formed on an upper portion of the rear surface of the glove box housing 30 along the horizontal direction. Accordingly, unlike the related art in which it is required to take away the whole glove box from the dashboard, a user can easily exchange the air filter 15 through the air filter exchanging portion 35 after opening the glove box cover 40.

On the other hand, according to an exemplary embodiment of the present invention, since cooled air of the air conditioning device 10 that flows into the glove box 50 is discharged to the outside of the glove box housing 30 through the air filter exchanging portion 35, the cooled air is not discharged through a gap of the glove box 50, and thus passenger's knees are prevented from being cold.

That is, in order to implement the cooling function of the glove box 50, a cooled air inflow hole for inflow of the cooled air of the air conditioning device 10 is formed on a side surface of the glove box 50, and the cooled air flowing into the glove box 50 cools the inside of the glove box 50. However, in the related art, since the air discharge hole for discharging the cooled air to the outside is not formed on the glove box 50, the cooled air is discharged through the gap of the glove box 50 to cause the passenger's knees to be cold. According to an exemplary embodiment of the present invention, the air filter exchanging portion 35 acts as a substitute for the cooled air discharge hole, and thus the above-described problem can be solved.

Hereinafter, a procedure of exchanging the air filter 15 through the structure for exchanging the air filter for a vehicle as constructed above according to an exemplary embodiment of the present invention will be briefly described with reference to FIG. 4.

First, in order to exchange the air filter 15, a user opens the glove box cover 40 (refer to solid lines) that closes the glove box housing 30 (refer to dotted lines).

Thereafter, after the air filter cover 20 that covers the air filter 15 is opened through the air filter exchanging portion 35 of the glove box housing 30, the air filter 15 is pulled forward to draw out the air filter 15 through the air filter exchanging portion 35, and then a new air filter is drawn in through the air filter exchanging portion 35.

As described above, according to an exemplary embodiment of the present invention, unlike the related art in which it is required to take away the whole glove box from the dashboard in order to exchange the air filter, a user can easily exchange the air filter 15 through the air filter exchanging portion 35 of the glove box housing 30 that communicates with the air filter 15 to improve the workability.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A structure for exchanging an air filter for a vehicle, comprising:
the air filter accommodated in an air conditioning device; and
a glove box housing provided on a dashboard and having an accommodation space formed therein,
wherein the air filter exchanging portion is formed on the glove box housing inside thereof to communicate with the air filter.

2. The structure for exchanging the air filter according to claim 1,
wherein an air filter cover for opening and closing the air filter is mounted on an inlet portion of the air conditioning device through which the air filter is drawn in and out, and
wherein the inlet portion of the air conditioning device is disposed in the glove box housing.

3. The structure for exchanging the air filter according to claim 2, wherein the air filter exchanging portion is penetratingly formed on an upper portion of one side surface of the glove box housing that faces the air filter and covered by the air filter cover.

4. The structure for exchanging the air filter according to claim 3, wherein the air filter is installed through the inlet portion of the air conditioning device and is inclined downward at a predetermined angle toward the air filter exchanging portion.

5. The structure for exchanging the air filter according to claim 1, wherein an inlet portion of the air conditioning device through which the air filter is drawn in and out is projected for a predetermined distance toward a glove box cover.

6. The structure for exchanging the air filter according to claim 1, wherein cooled air of the air conditioning device that flows into the glove box housing is discharged to an outside through the air filter exchanging portion.
